(19) United States
(12) Patent Application Publication
(10) Pub. No.: US 2010/0109528 A1
(43) Pub. Date: May 6, 2010

(54) FOIL SEALED LAMP

(75) Inventor: Osamu Shirakawa, Ehime (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Harison Toshiba Lighting Corporation, Imabari-shi (JP)

(21) Appl. No.: 12/594,722

(22) PCT Filed: Dec. 26, 2007
(86) PCT No.: PCT/JP07/75011

§ 371 Date: Oct. 5, 2009

(30) Foreign Application Priority Data
Apr. 5, 2007 (JP) 2007-099168

(51) Int. Cl. H01J 61/36

(52) U.S. Cl. 313/623

(57) ABSTRACT

A foil sealed lamp including an airtight container including a discharge portion provided thereinside with a discharge space and seal parts disposed at both ends of the discharge portion; metal foils of thickness T (μm) hermetically attached to the seal portions; a pair of electrodes each having its one end connected to the metal foil and having its other end led out to the discharge space; and on the periphery of areas of connection of the metal foils with the pair of electrodes, multiple recessed portions satisfying 1.0 (μm)≦D≦T (μm) wherein D refers to the depth (μm), in a manner that the recessed portions do not overlap one another.

### TECHNICAL FIELD

The present invention relates to a foil sealed lamp configured such that metallic foils are sealed in the sealing portions of the foil sealed lamp, respectively. The foil sealed lamp functions as a high-pressure discharge lamp which would be employed for a headlight of an automobile, a projector or the like.

### BACKGROUND ART

A lamp with sealing portions in which metallic foils are sealed (hereinafter, called as a “foil sealed lamp”) is taught in JP-A 11-238488 (KOKAI) (Japanese Patent Application Laid-open 11-238488; hereinafter, called as “Patent Reference 1”). It is important to seal the metallic foils in the sealing portions of the foil sealed lamp in view of maintaining the interior of the lamp under airtight condition.

In such a foil sealed lamp as described above, there is provided a problem that the metallic foils are peeled off from the glass to form cracks in the sealing portions, thereby causing a gas leak through the cracks. In this case, the lamp cannot be lighted due to the gas leak, which is called as “foil leak”. In order to prevent the foil leak, JP-B2 3150918 (Patent Registration) (hereinafter, called as “Patent Reference 2”), JP-A 2001-266794 (KOKAI) (hereinafter, called as “Patent Reference 3”) and JP-A 2005-259403 (KOKAI) (hereinafter, called as “Patent Reference 4”) are filed. Patent Reference 2 teaches a metal halide discharge lamp configured such that satin process is conducted for the surfaces of the metallic foils by means of sandblast or the like. Patent Reference 3 teaches a high-pressure discharge lamp configured to have through-holes penetrating the metallic foils. Patent Reference 4 teaches a discharge lamp configured such that slits are formed at the edges of the metallic foils.

[Patent Reference 1] JP-A 11-238488 (KOKAI)

[Patent Reference 2] JP-B2 3150918 (Patent Registration)

[Patent Reference 3] JP-A 2001-266794 (KOKAI)

[Patent Reference 4] JP-A 2005-259403 (KOKAI)

### DISCLOSURE OF THE INVENTION

As apparent from the above-description, various attempts have been made for preventing the foil leak. However, some users desire a lamp with excellent lifetime performance so that further improvements are required.

One object of the present invention is to provide a foil sealed lamp capable of preventing the foil leak.

In order to achieve the object of the present invention, one aspect of the present invention relates to a foil sealed lamp, including: an airtight container having a light emission portion in which a space is formed and a sealing portion provided at least one end of the light emission portion; a metallic foil with a thickness of T (μm) sealed in the sealing portion; a conductor of which one end is connected with the metallic foil and of which the other end extends into the space; wherein a plurality of recessed portions are formed on a main surface of the metallic foil so as not to be overlapped one another in a manner that when a depth of the recessed portion is defined as “D (μm)”, a relation of 1.0 μm≦D<T (μm) is satisfied.

According to the present invention a foil sealed lamp capable of preventing the foil leak is provided.

### BRIEF DESCRIPTION OF DRAWINGS

FIG. 1 is a side view relating to a first embodiment of a metal halide lamp according to the present invention.

FIG. 2 is a top view of the metal halide lamp according to the present invention.

FIG. 3 is an enlarged view of the area X₁ shown in FIG. 2.

FIG. 4 is a cross sectional taken along the line Y₁-Y₁′.

FIG. 5 is an enlarged view of the area X₂ shown in FIG. 4.

FIG. 6 is an explanatory view relating to one specification of the metal halide lamp in FIG. 1.

FIG. 7 is shows the rate of occurrence of foil leak after the metal halide lamp is lighted for 2000 hours, varying the depth “D” of a depressed portion.

FIG. 8 shows the time when the first foil leak occurs during the first lighting in shown the test in FIG. 7.

FIG. 9 shows the rate of occurrence of foil leak after the metal halide lamp is lighted for 2000 hours, varying the width “W” of the depressed portion.

FIG. 10 shows the time when the foil leak occurs during the first lighting in the test shown in FIG. 9.

FIG. 11 is an explanatory view relating to a second embodiment of a metal halide lamp according to the present invention.

FIG. 12 is an enlarged view of the area X₂ in FIG. 11.

FIG. 13 is an explanatory view relating to a third embodiment of a metal halide lamp according to the present invention.

FIG. 14 is an explanatory view relating to a fourth embodiment of a metal halide lamp according to the present invention.

FIG. 15 is an explanatory view relating to a modified fourth embodiment of a metal halide lamp according to the present invention.

FIG. 16 is an explanatory view relating to a fifth embodiment of a metal halide lamp according to the present invention.

### BEST MODE FOR CARRYING OUT THE INVENTION

Other characteristics and advantages of the present invention will be hereinafter described with reference to the detailed embodiments.

### First Embodiment

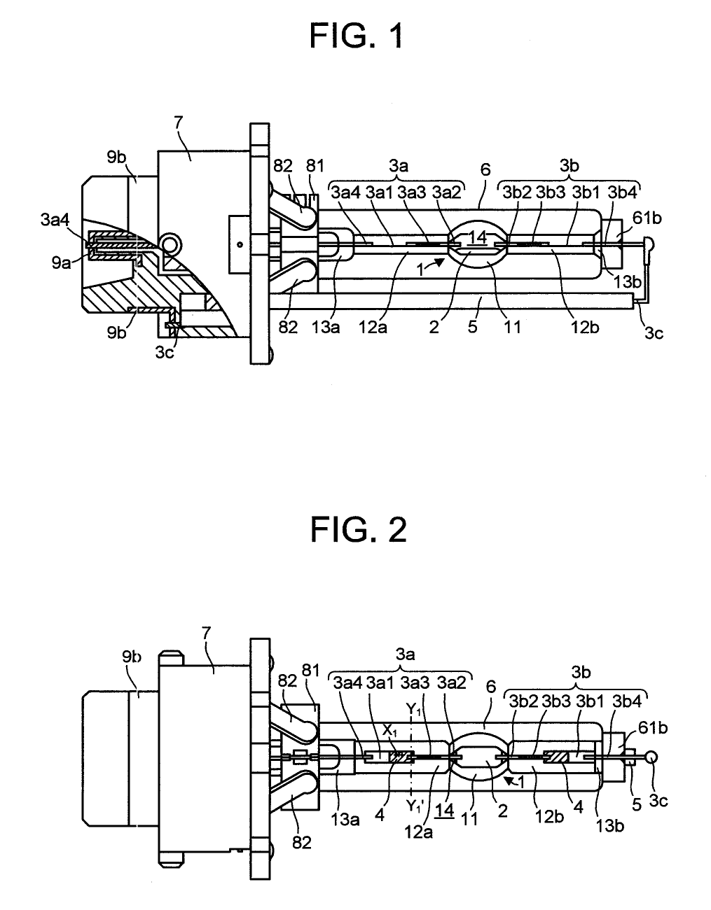

A metal halide lamp as one embodiment of the foil sealed lamp will be described with reference to the drawings. FIG. 1 is a side view relating to a first embodiment of the metal halide lamp according to the present invention. FIG. 2 is a top view of the metal halide lamp according to the present invention.

The metal halide lamp includes an airtight container 1 made of quartz glass as a main body. The airtight container 1 is shaped in an elongated form along the lamp axis direction and a substantially elliptical discharge portion 11 is formed as a light emission portion substantially at the center of the airtight container 1. Sealing portions 12a, 12b, which are pinch-sealed to form a platy portion, are formed at both ends of the discharge portion 11, and non-sealed portions 13a, 13b are formed at both ends of the sealing portions 12a, 12b. The airtight container 1 is desirably made of a material, which is heat-resistant and transparent, such as quartz glass.

A discharge space 14 is formed in the discharge portion 11 along the lamp axis direction. The discharge space 14 is configured such that the center thereof is shaped in a substantially columnar form and the both ends are shaped in a tapered form. The volume of the discharge space 14 is preferably set within a range of 10 mm³ to 40 mm³ when the metal halide lamp is used as a headlight of an automobile.

A discharge medium constituted from a metallic halide and an inert gas is included in the discharge space 14. The metallic halide contains sodium iodide (NaI), scandium iodide (ScI), zinc iodide (ZnI₂) and indium bromide (InBr). Here, the kind of halogen bonded with the metal as the metallic halide, other than scandium iodide, is not limited to the ones mentioned above, but iodine, bromine or a combination of plural kinds of halogen may be employed.

A xenon gas is included as the inert gas in the discharge space 14 because the Xe gas can exhibit high luminous efficiency immediately after the metal halide lamp is activated and thus, can function as a starter gas. It is desired that the pressure of the Xenon gas is 5 atm or more at ordinary temperature (25° C.) and set within a range of 11 to 20 atm in use for a headlight of an automobile. Inert gas may be a neon gas, an argon gas, a krypton gas or the like or any combination thereof, other than the xenon gas.

Mercury is not essentially contained in the discharge space 14. The phrase “mercury is not essentially contained in the discharge space 14” means either mercury is not contained in the discharge space 14 at all or mercury is not substantially contained in the discharge space 14, for example, it is acceptable when mercury is existent within a range of less than 2 mg/ml, preferably less than 1 mg/ml.

Mounting portions 3a, 3b are sealed in the sealing portions 12a, 12b, respectively. The mounting portions 3a, 3b are integrally configured by metallic foils 3a1, 3b1, electrodes 3a2, 3b2, coils 3a3, 3b3 and outer lead wires 3a4, 3b4.

The metallic foils 3a1 and 3b1 are thin plates made of molybdenum (Mo), for example. On the main surfaces of the metallic foils 3a1, 3b1 in the vicinity of the connections with the electrodes 3a2, 3b2, respectively, processed portions 4 are formed. The processed portion 4 is a group of a plurality of recessed portions 41 as described hereinafter. Here, the wording “main surface” means the surface of the metallic film 3a1 or 3b1 orthogonal to the thickness direction of thereof, and thus, generally corresponds to the “front surface” or the “rear surface” relative to the side surface. The phrase “the recessed portions are formed on the main surface of the metallic foil in the vicinity of the connection with the electrode” means at least one, preferably a plurality of recessed portions 41 are formed on the main surface of the metallic foil 3a1, 3b1 in the area within a radius of less than 0.5 mm, preferably 0.25 mm from the electrode 3a2, 3b2. The processed portion 4 and the recessed portion 41 will be described below in more details.

The electrodes 3a2, 3b2 are thoriated tungsten electrodes, which are made by doping thorium oxide elements to tungsten. The base portions of the electrodes 3a2, 3b2 are connected with the end portions of the metallic foils 3a1, 3b1 at the side of the discharge portion 11 by means of laser welding. The front portions of the electrodes 3a2, 3b2 (opposite to the base portions) are disposed so as to be opposite to one another by a predetermined electrode distance in the discharge space 14. The predetermined electrode distance may be preferably about 4.2 mm as viewed externally, not as measured practically in the use of the headlight of an automobile. The shapes of the electrodes 3a2, 3b2 are not limited to the stick form as in this embodiment, but may be in a non-stick form where the diameters of the forefronts of the electrodes 3a2, 3b2 are enlarged or may be formed to have different sizes from one another to be used for a DC lighting type lamp.

The coils 3a3, 3b3 may be made of, for example, doped tungsten, and wound helically around the axes of the electrodes 3a2, 3b2 attached to the seal portions 12a, 12b. However, the coils 3a3, 3b3 are not wound around the axes of the electrodes 3a2, 3b2 at the connections with the metallic foils 3a3, 3b3. The coils 3a3, 3b3 are provided and wound so as to prevent, what is called, an axial leak occurring at the sealing portions 12a, 12b, and in this point of view, longer coil wound length and smaller coil pitch is more effective (e.g., the coil wound length is 60% or more relative to the sealed electrode length; the coil pitch is 400% or less). On the other hand, halogen is likely to move toward the metallic foils 3a3, 3b3 and thus, would induce the foil leak; the problems due to the foil leak, however, can be alleviated by the present invention.

The outer lead wires 3a4, 3b4 may be made of molybdenum, for example, and connected with the end portions of the metallic foils 3a1, 3b1 opposite to the discharge portion 11 by means of welding or the like. The other end of the outer lead wires 3a4, 3b4 extend outward along the lamp tube axis, and further extend outward through substantially at the center of the non-sealed portions 13a, 13b. One end of an L-shaped supporting wire 3c made of nickel is connected to the lead wire 3b4 at its front side. The other end of the supporting wire 3c extends toward a socket 7 described hereinafter. The supporting wire 3c extending parallel to the lamp tube axis is covered with a sleeve 5 made of ceramic: material.

A cylindrical outer tube 6 is provided concentrically in the outside of the airtight container 1 along the lamp tube axis. The outer tube 6 is made of quartz glass with an additive of oxide of titanium, cerium, aluminum or the like, so as to block ultraviolet. The connection is established by melting the tubular non-sealed portions 13a, 13b located at both sides of the airtight container 1 and both ends of the outer tube 6. In this way, the welding portions 61a, 61b are formed at both ends of the airtight container 1 and the outer tube 6. Nitrogen or a rare gas such as neon, argon and xenon or a mixture thereof may be included in the space between the airtight container 1 and the outer tube 6.

The socket 7 is connected with the non-sealed portion 13a of the outer tube 6 covering the airtight container 1 therewithin. The connection is established by holding metallic bands 81 attached to the outer periphery of the outer tube 6 in the vicinity of the non-sealed portion 13a with four metallic tongue-shape plates 82 (in FIG. 1, only two plates are depicted) formed at the opening edge of the socket 7 in the holding side of the airtight container 1. The contacting points between the metallic bands 81 and the tongue-shaped plates 82 are welded by means of laser welding in order to enhance the strength of the connection. A bottom terminal 9a is provided at the bottom of the socket 7 with which a lead wire 3a4 is connected, and a side terminal 9b is provided at the side of the socket 7 with which the supporting wire 3c is connected.

The metal halide lamp configured as described above is disposed in a manner that the lamp tube axis lies substantially horizontal. A lighting circuit is connected to the bottom terminal 9a and the side terminal 9b so that the metal halide lamp is lighted at an electric power of about 35 W during a stable period, and at an electric power of about 75 w at the start-up stage, more than twice the power during the stable period.

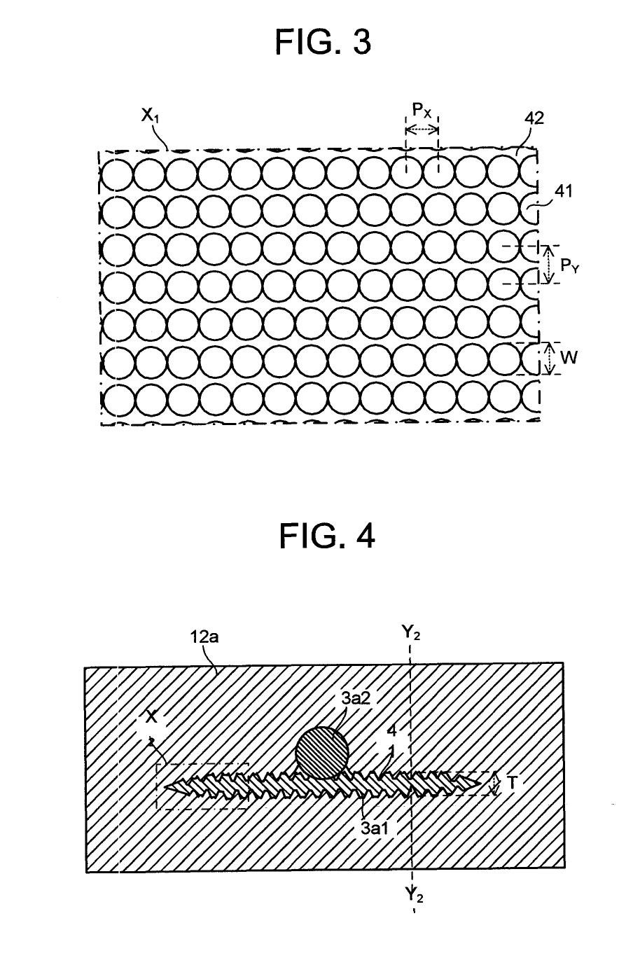

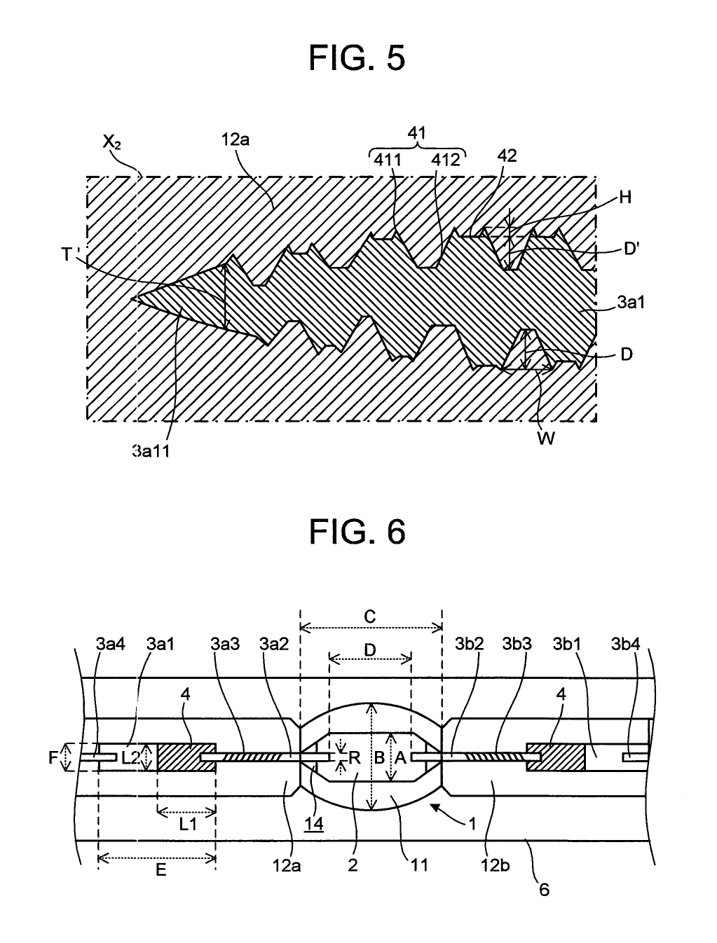

The processed portions 4 formed on the surface of the metallic foils 3a1, 3b1 will be described in detail. FIG. 3 is an enlarged view of the area X₁ shown in FIG. 2. FIG. 4 is a cross sectional view taken on line Y₁-Y₁′ in FIG. 2. FIG. 5 is an enlarged view of the area X₂ in FIG. 4.

The processed portion 4 includes a plurality of substantially circular recessed portions 41 which do not overlap one another and are arranged substantially regularly on the surface of the metallic foil. Concretely, the adjacent recessed portions are arranged substantially continuously in contact with one another in the long direction of the corresponding metallic foil. On the other hand, the adjacent recessed portions arranged in the short direction of the corresponding metallic foil are not in contact with one another so that non-processed area 42 remains. Namely, the pitch P_{X} in the long direction is equal to the width W of the recessed portion 41 and the pitch P_{Y} in the short direction is larger than the width W of the recessed portion 41. In the case that the non-processed area is formed as in this embodiment, preferably, the pitch P_{Y} satisfies the following relation of W<P_{Y}≦200 μm in view of the occurrence of the foil leak.

The term “substantially circular” encompasses circular shape, elliptical shape and a composite circular shape where a portion is shaped linearly and a major part is shaped circularly. The term “substantially regularly” means a state with a given regularity. If the recessed portions 41 are formed regularly, the metallic foils 3a1, 3b1 with the processed portions 4 can be expected to have substantially the same property even though the metallic foils 3a1, 3b1 are made by mass production. Therefore, the reproducibility and reliability in the effect/function of the metallic foils 3a1, 3b1 can be enhanced in comparison with the case where surface roughness is randomly formed on a metallic foil by means of blasting or the like. Even though some erroneous or intended deviations from the regularity occur, the definition of “substantially regularly” can be satisfied only if these errors and deviations do not affect the inherent effects/functions of the metallic foils 3a1, 3b1.

The term “not overlap one another” means the state where the adjacent recessed portions 41 do not overlap one another. If the recessed portions 41 do overlap, e.g., almost the half area of one of the recessed portion 41 is overlapped with almost the half area of the adjacent one of the recessed portions 41, the surface area of the recessed portions 41 is undesirably decreased in the overlapping direction. However, the overlap to the extent which the decrease in the surface area of the recessed portions 41 is small and ignorable is allowable. The term “substantially continuously” means that the adjacent recessed portions 41 are contacted with one another as shown in FIG. 3 or approximate to one another. In this way, if the recessed portions 41 are formed almost continuously, the non-processed area 42 is decreased on the corresponding metallic foil so that the surface area of the corresponding metallic foil can be increased. Therefore, the adhesion between the metallic foil and the glass can be enhanced, as well as remarkably delaying the halogen diffusion. The continuous direction is not limited to the long direction of the metallic foil, but any direction may be taken.

The term “non-processed area” refers to an area which are not affected by the recessed portions 41 and normally, refers to a surface with small roughness, but not preclude surface without roughness. Namely, the non-processed area 42 may have surface roughness in advance so that the processed portion 4 may include both the recessed portions 41 and the non-processed area 42 with surface roughness.

As apparent from FIG. 4, on the other hand, each of the recessed portions 41 is shaped in substantially an inverted trapezoidal form, and are formed on both of the front surface and rear surface of the metallic foil 3a1 at substantially an equal intervals. When an attention is paid to the Y₂-Y₂′ line, the recessed portions 41 formed on the front surface of the metallic foil 3a1 are shifted from the recessed portions 41 formed on the rear surface of the metallic foil 3a1, respectively. Therefore, even though the recessed portions 41 are formed on the front surface and rear surface of the metallic foil 3a1, the recessed portions 41 are unlikely to penetrate through the metallic foil 3a1. The shift degree between the front surface and rear surface of the recessed portions 41 is preferably set to W/2 (μm). In this case, the recessed portions 42 can be formed much deeper on the front surface and rear surface of the metallic foil 3a1.

As apparent from FIG. 5 relating to the enlarged view of the area X₂, each of the recessed portions 41 include a protrusion 411 higher than the surface level of the non-processed area 42 and a depressed portion 412 lower than the surface level of the non-processed area 42. Since the contact area between the recessed portions 41 and the glass can be increased by the protrusions 411 of the recessed portions 41, the adhesion between the metallic foil 3a1 and the glass can be enhanced. Since the depth “D” of each of the recessed portion 41 can be larger than the depth “D′” of the corresponding depressed portions 412 by the protrusion height “H”, the halogen diffusion toward the metallic foil 3a1 can be even more delayed. The protrusion height “H” may be preferably set within a range of more than zero and not more than 0.5 μm (0<H≦0.5 μm).

Moreover, the metallic foil 3a1 (and the metallic foil 3b1) has a knife-edge portion 3a11 at both ends thereof. Therefore, the adhesion between the knife-edge portion 3a11 and the glass is enhanced. Here, the term “knife-edge portion” means the thickness of the end of the foil is smaller than the substantial thickness of the foil so that the knife-edge portion 3a11 may be tapered sharply or gently. Since the adhesion between the metallic foil 3a1 and the glass is decreased when the end of the metallic foil 3a1 is roughed and destructed in shape, no recessed portion is formed at the knife-edge portion 3a11 of which the thickness is smaller than the depth of the recessed portion 41, which means no recessed portion is formed on the end of the metallic foil 3a1 in the short direction. In order to further ensure the reliability, when the thickness of a given portion of the knife-edge portion 3a11 is “T′”, no recessed portion is formed at the area of the knife-edge portion 3a11 where the thickness “T′” is smaller than the depth “D” of the recessed portion 41 in view of the recessed portions 41 being formed on either surface or both surfaces of the metallic foil 3a1.

Next, a forming method of the processed portion 4 will be described. The processed portion 4 can be formed by means of laser processing. According to the laser processing by which one recessed portion 41 can be formed per one shot of laser, a desired processed portion 4 can be formed by conducting the laser shot repeatedly and successively at every predetermined pitch. The laser processing can be also controlled so as to avoid a particular position where the recessed portion not to be formed such as the knife-edge portion 3a11 and the thinner portion of the metallic foil in the vicinity of the end thereof in the long direction thereof. The width “W” and depth “D” can be controlled by changing a spot diameter of the laser irradiating portion or an input electric current value to a laser device to be employed. The protrusions 411 are formed during the formation of the recessed portions 41 by means of the laser irradiation, and the height of each of the protrusions 41 is likely to be large as the irradiating laser power is increased. The inverted trapezoidal recessed portions 41 in this embodiment can be formed by slightly shifting the focus of the irradiating laser.

FIG. 6 is an explanatory view about one specification of the metal halide lamp in FIG. 1. The specification will be listed below. Various tests are conducted for the metal halide lamp formed according to the listed specification only if not particularly referred to.

Discharge container 1: Made by quartz glass, Interior volume=27.5 mm³, Inner diameter “a”=2.5 mm, Outer diameter “B”=6.2 mm, Spherical portion diameter “C” in long direction=7.8 mm

Metallic halide 2: ScI₃=0.068 mg, NaI=0.109 mg, ZnI₂=0.022 mg, InBr=0.0005 mg

Rare gas: xenon=13.5 atm

Mercury: 0 mg

Metallic foils 3a1, 3b1: Made of Molybdenum, Length “E”×Width “F”=6.5 mm×1.5 mm, Thickness “T”=20 mm

Electrodes 3a2, 3b2: Made of thoriated tungsten, Diameter “r”=0.38 mm, Interelectrode distance “D”=4.2 mm (Practical interelectrode distance: 3.75 mm)

Processed portion 4: Forming area L1×L2=3.0 mm×1.3 mm

Recessed portion 41: Width “W”=38 μm, Depth “D”=2.0 μm (Height “H” of protrusion 411=0.5 μm, Depth “D′” of depressed portion 412=1.5 μm), Pitch P_{X} in long direction=38 μm, Pitch P_{Y} in short direction=50 μm, Made by flowing current of 18 (A) in YAG laser with laser irradiating diameter of about 30 μm

Coils 3a3, 3b3: Made of doped tungsten, Line diameter=0.06 mm, Pitch=250%, Winding length=3.2 mm

Outer lead wires 3a4, 3b4: Made of Molybdenum, Diameter=0.6 min

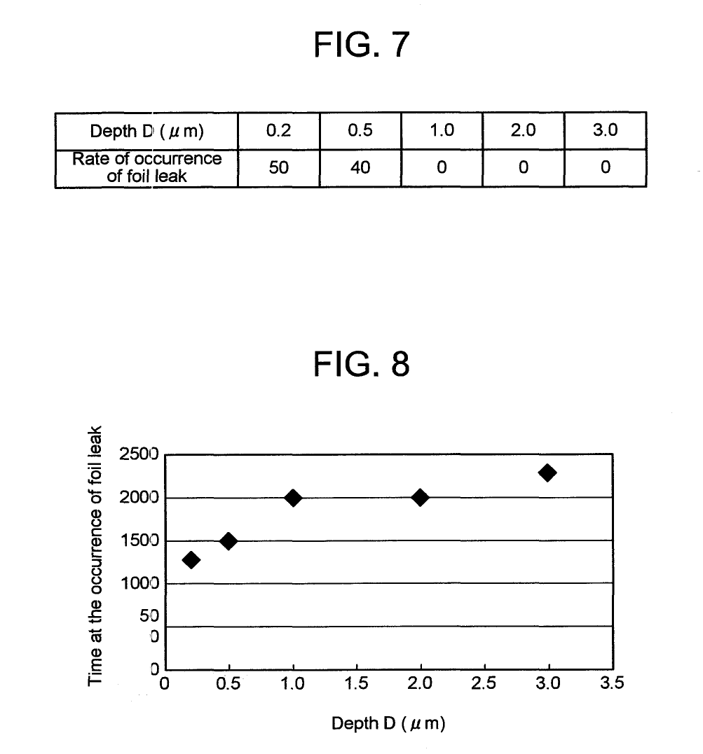

FIG. 7 shows the rate of occurrence of foil leak after the metal halide lamp is lighted for 2000 hours, varying the depth “D” of the depressed portion. The test condition is based on the flashing cycle of EU 120 minutes mode defined by JEL215 of HID standard relating to an automobile headlight. The number of the metal halide lamp to be supplied for the test was set to 12. The depth “D” of the recessed portion 41 is varied by changing the input electric current at the laser irradiation. The measurement was carried out by observing the cross section of the foil by means of a electron microscope and by averaging the portions where the corresponding concave-convex structures were relatively uniform.

As a result, it is turned out that the rate of occurrence of foil leak is relatively high with the depth “D” of the recessed portion 41 of 0.2 μm and 0.5 μm, but given the depth “D” of the recessed portion 41 of 1.0 μm or more, it can be suppressed within a time range of 2000 hours. FIG. 8 shows the time when the first foil leak is observed at the test referring to FIG. 7. As apparent from FIG. 8, if the depth “D” is set to 3.0 μm or more, the occurrence of foil leak at the initial lighting stage can be prevented for 2300 hours. It can be understood that these results are related with the contacting area between the glass and the foil and the halogen diffusion delay. Namely, if the recessed portions 41 are not deep, the adhesion between the glass and the foil is not sufficient. The distance across the surface of the foil from a position approximate the connection between the metallic foils 3a1, 3b1 and the electrodes 3a2, 3b2 to the ends of the metallic foils 3a1, 3b1 in the short direction so that halogen could reach to the ends of the metallic foils 3a1, 3b1 in the short direction for a short period of time, thereby increasing the rate of occurrence of foil leak. In other words, the foil leak can be suppressed as the depth “D” of the recessed portion is increased. However, if the recessed portions 41 are formed so as to penetrate through the metallic foils 3a1, 3b1, cracks around the through-holes formed by the penetration of the recessed portions 41 may be formed. Therefore, it is required that the depth “D” is set smaller than the thickness “T” of the foil. In this point of view, it is desired that the depth “D” satisfies the relation of 1.0 μm≦D<T (μm), preferably 3.0 μm D<T (μm).

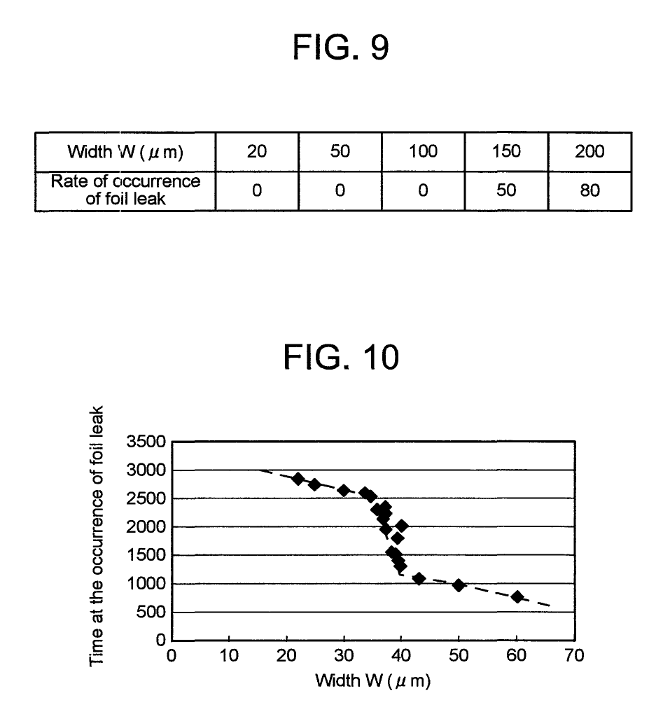

FIG. 9 shows the rate of occurrence of foil leak after the metal halide lamp is lighted for 2000 hours varying the width “W” of the depressed portion. The testing condition is set in the same manner as the test referring to FIG. 7.

As a result, it is turned out that the rate of occurrence of foil leak is relatively high with the width “W” of the recessed portion 41 of 150 μm or 200 μm, but it can be suppressed with the width “W” less than 100 μm within a time range of 2000 hours. According to FIG. 10 which shows the time when the first foil leak is observed at the test referring to FIG. 9, if the width “W” is set to 40 μm or less, the occurrence of foil leak can be suppressed for 2500 hours. In other words, the foil leak can be suppressed as the width “W” of the recessed portion is decreased. However, since too small width “W” of the recessed portion 41 increases the number of laser irradiation to deteriorate the production efficiency of the foils, the lower limited value of the width “W” is preferably set to 10 μm. Therefore, it is desired that the width “W” satisfies the relation of 10 μm≦W<100 μm, preferably 10 μm≦W<40 μm and more preferably 10 μm≦W<35 μm.

The adhesions between the metallic foils 3a1, 3b1 and the corresponding sealing portions 12a, 12b are related to average surface roughnesses Ra (μm) and Rz (μm). In this point of view, the lighting test of EU mode was conducted under the condition that the average surface roughnesses Ra (μm) and Rz (μm) of the processed portion 4 are changed. As a result, it is found if the relations of 0.4 μm≦Ra and 1.0 μm≦Rz 7.0 μm are satisfied, the foil leak can be more effectively suppressed. The average surface roughnesses Ra (μm) and Rz (μm) of the processed portion 4 are measured for the area of 230 μm² based on JIS B0601 at a magnification power of 50×. In the present invention, the average surface roughnesses Ra (μm) and Rz (μm) can be varied by changing the depth “D”, width “W”, and pitches P_{X}, P_{Y} and the like.

In this embodiment, therefore, if the recessed portions 41 with the depth “D” satisfying the relation of 1.0 μm≦D<T (μm) are formed at the front surface and the rear surface of the metallic foils 3a1, 3b1 so as not to be overlapped one another, the foil leak due to peeling of the metallic foils 3a1, 3b1 from the glass at the connections between the metallic foils 3a1, 3b1 and the electrodes 3a2, 3b2 can be suppressed. Moreover, since halogen diffusion can be delayed in the short direction, the foil leak can be also suppressed.

Since the recessed portion 41 includes the protrusion 411 raised relative to the non-processed area 42 and the depressed portion 412 caved in relative to the non-processed area 42, the adhesion between the metallic foils 3a1, 3b1 and the glass is increased while the halogen diffusion is delayed, so that the foil leak can be more effectively suppressed.

Moreover, since the recessed portions 41 are formed substantially regularly on the surfaces of the metallic foils 3a1, 3b1, the metallic foils 3a1, 3b1 with the recessed portions 41 can be made under high reproducibility and thus, can exhibit the same effect/function under high reliability. Therefore, the foil leak can be suppressed.

If the recessed portions 41 are formed such that the adjacent recessed portions 41 are contacted with one another, the non-processed portion 42 is narrowed so that the adhesion between the metallic foils 3a1, 3b1 and the glass can be enhanced and the halogen diffusion delay can be also enhanced. Therefore, the foil leak can be more effectively suppressed.

Furthermore, if the recessed portions 41 are formed on both surfaces of each of the metallic foils 3a1, 3b1 so as to be shifted from one another, the recessed portions 41 can be formed so as not to penetrate through the metallic foils 3a1, 3b1. As a result, the recessed portions 41 can be formed deeper.

In addition, in the case that the metallic foils 3a1, 3b1 have the knife-edge portions 3a11 at the ends thereof in the short direction, the performance and function of the knife-edge portion 3a11 cannot be deteriorated by not forming the recessed portions 41 at the area of the knife-edge portion 3a11 where the thickness of the knife-edge portion 3a11 is smaller than the depth “D” of the recessed portions 41.

The recessed portions 41 can be formed by means of laser irradiation so as to have the respective depths and widths at the respective positions as desired, and thus can be formed in a desired pattern. Namely, the recessed portions 41 can be easily formed substantially regularly or so as to be substantially continuously contacted with one another or so as not to be formed on a given area of the knife-edge portion 3a11. According to the laser irradiation, the protrusions 411 can be easily formed.

In the lamp configured such that the metallic halide 2 is included in the discharge space 14, the foil leak is likely to occur due to the halogen diffusion from the discharge space 14 to an end of the metallic foils 3a1, 3b1 in the short direction during the lighting of the lamp. In this embodiment, however, since the halogen diffusion can be delayed by the recessed portions 41 in the short direction, the foil leak can be suppressed.

In the lamp configured such that mercury is not substantially included in the discharge space 14, excessive load tends to be applied onto the metallic foils 3a1, 3b1 in comparison with a conventional lamp, leading the foil leak. In this embodiment, however, the foil leak can be suppressed by the recessed portions 41.

### Second Embodiment

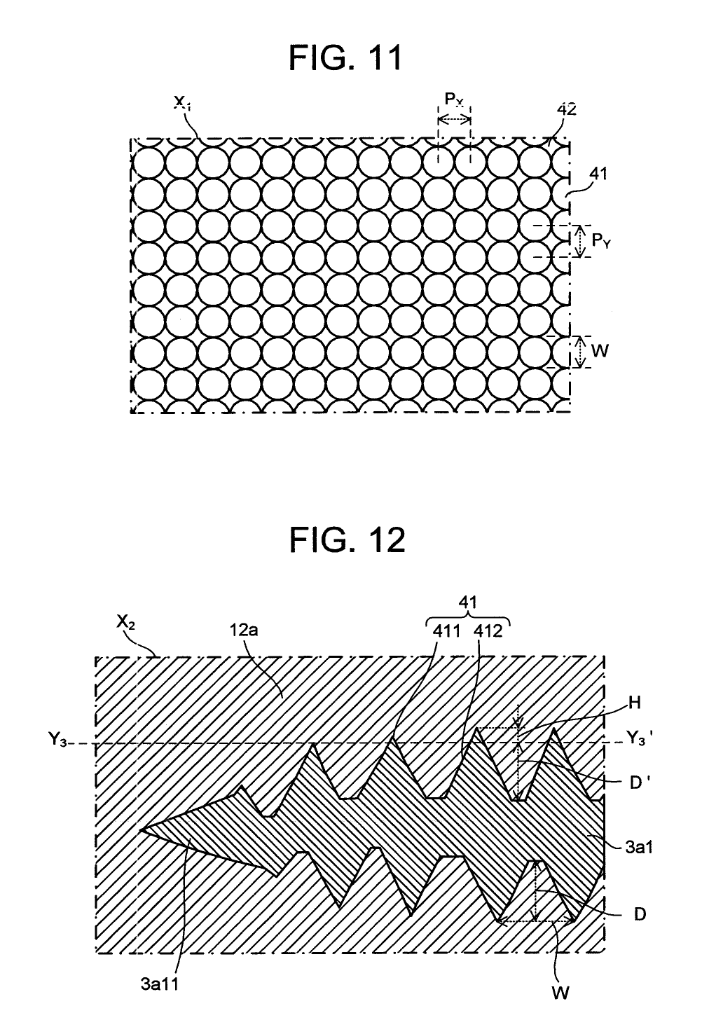

FIG. 11 is an explanatory view relating to a second embodiment of a metal halide lamp according to the present invention. Corresponding components are designated by the same reference numerals throughout the drawings, and thus, omitted in explanation.

In this second embodiment, the recessed portions 41 are formed so as to be contacted with one another in the long direction and the short direction. Namely, the pitch P_{X} in the long direction and the pitch P_{Y} in the short direction are substantially under the same condition with respect to the width “W” of the recessed portion 41. Therefore, the non-processed area 42 is much narrowed, and the contacting area between the glass and the foil can be more increased. According to FIG. 12 shows an enlarged view of the area X₂ of the metal halide lamp in FIG. 11, as similarly depicted in FIG. 5, the protrusions 411 are raised relative to the surface level of the non-processed area 42 (indicated by line Y₃-Y₃′) . Since the protrusion 411 is superimposed onto the protrusion portion of the recessed portion 41 adjacent thereto, the height of the protrusion 411 in this embodiment becomes relatively larger than the height of the protrusion 411 in the first embodiment.

Therefore, the metal halide lamp in this embodiment can suppress the foil leak more than the one in the first embodiment.

### Third Embodiment

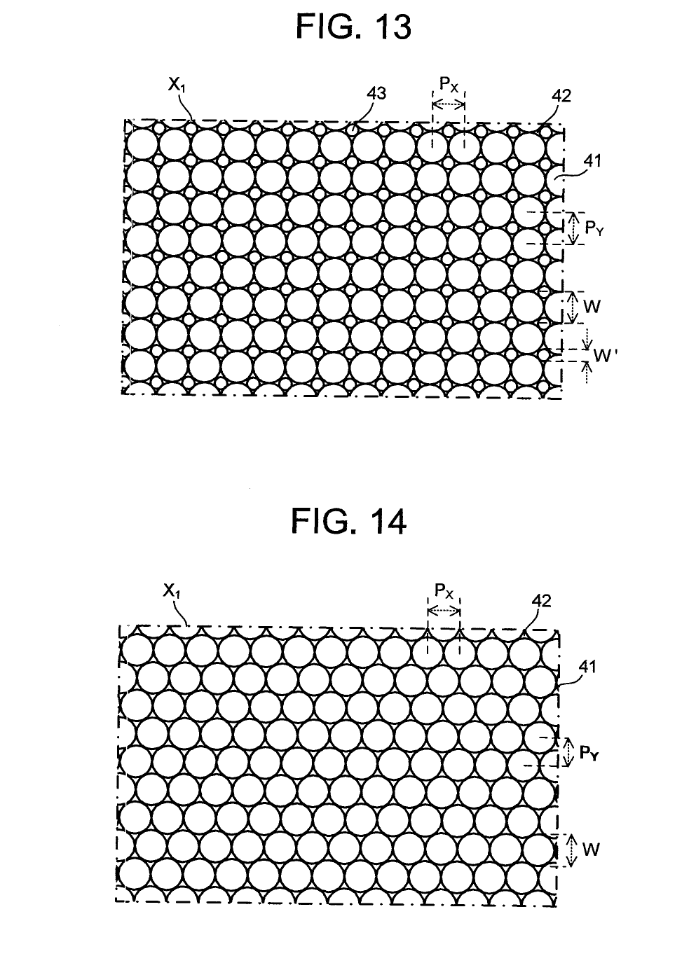

FIG. 13 is an explanatory view relating to a third embodiment of a metal halide lamp according to the present invention.

In this third embodiment, small recessed portions 43 are formed in the corresponding small areas of the non-processed area 42 existent diagonally among the recessed portions 41 arranged as in the second embodiment. The size of small recessed portions 43 is smaller than the size of the recessed portions 41. Concretely, the width “W′” of the recessed portion 43 is 8 μm, while the width “W” of the recessed portions 41 is 38 μm, and the recessed portions 43 is contacted with the recessed portions 41 at the corresponding four contacting points. Therefore, the non-processed area 42 is much narrowed so that the contacting area between the glass and the foil can be increased more than that of the second embodiment.

Therefore, the metal halide lamp in this embodiment can suppress the foil leak more than the one in the second embodiment.

### Fourth Embodiment

FIG. 14 is an explanatory view relating to a fourth embodiment of a metal halide lamp according to the present invention.

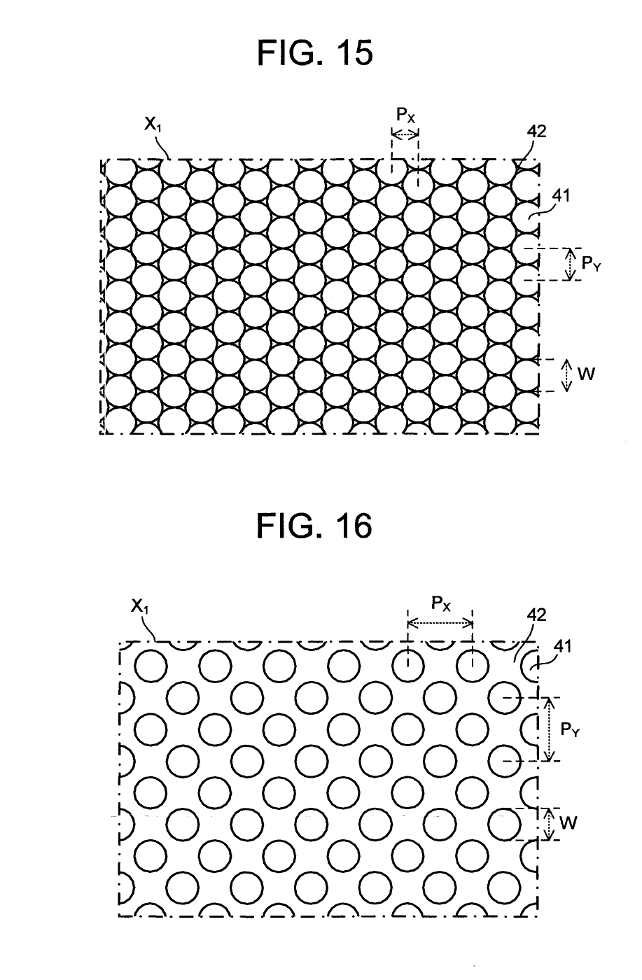

In this fourth embodiment, the recessed portions 41 each having the same width “W” are formed as in the second embodiment. However, the pitch P_{X} in the long direction is set to “W” and the pitch P_{Y} in the short direction is set to “(γ3/2)W”. Each of the recessed portions 41 is contacted with six adjacent recessed portions 41 at the corresponding six contacting points. Therefore, the non-processed area 42 is much narrowed so that the contacting area between the glass and the foil can be much increased. In this embodiment, since the non-processed area 42 is narrowed by forming only the same size of the recessed portions 41, the process is relatively easy in comparison with the third embodiment. As indicated in FIG. 15, the above-described effect/function can be exhibited by setting the pitch P_{X} in the long direction to “(γ3/2) W” and setting the pitch P_{Y} in the short direction to “W”.

Therefore, the metal halide lamp in this embodiment can exhibit the same effect/function as that of the third embodiment with the relatively easy process for forming the recessed portions 41.

### Fifth Embodiment

FIG. 16 is an explanatory view relating to a fifth embodiment of a metal halide lamp according to the present invention.

In this fifth embodiment, the recessed portions 41 are formed so as not to be contacted with one another. In this case, although the non-processed area 42 is enlarged so that the contacting area between the glass and the foil is decreased to cause the slight decrease of the adhesion therebetween, yet the foil leak can be suppressed by the recessed portions 41. In this embodiment, the pitch P_{X} in the long direction is set to “2W” and the pitch P_{Y} in the short direction is set to “2W”.

Therefore, the metal halide lamp in this embodiment can exhibit the same effect/function as that of the first embodiment.

The present invention is not limited to the embodiments as described above. For example, the embodiments may be modified below.

The present invention is not limited to the metal halide lamp for the use of the headlight of an automobile as described above, but: the same advantages can be expected when applied to a foil sealed lamp with metallic foils sealed in the corresponding sealing portions such as a short arc lamp, a UV lamp which have relatively large discharge spaces and sealing portions, a halogen lamp and a halogen heater.

The sealing portions 12a, 12b may be made by means of shrink seal instead of the pinch seal to exhibit the same advantages.

The metallic foils 3a1, 3b1 may be made of rhenium-molybdenum, tungsten, rhenium-tungsten or the like instead can molybdenum to exhibit the same advantages. Namely, the constituent materials of the metallic foils 3a1, 3b1 are not limited. A thin film or layer may be formed on the foils.

An area where the processed portion 4 are formed is not always almost the half of the foils as shown in the first embodiment, but it can be practically effective when formed over a region at the connections between the metallic foils 3a1, 3b1 and the electrodes 3b1, 3b2 in the width direction of the foils. Yet since the adhesion between the glass and the foil is increased as the area formed with the processed portion 4 is increased, it is desired that the processed portions 4 are formed over the metallic foils 3a1, 3b1 substantially entirely.

The surface shape of the recessed portion 41 is not limited to the substantially circle form, but may be a polygonal form such as hexagon or octagon. The polygonal shape may be formed by means of laser irradiation in a manner that a desirably shaped mask is provided at the laser irradiating portion. In the case that the recessed portions 41 are continuously formed in the long direction as in the first embodiment, the recessed portions 41 may be arranged in a waveform or a triangular waveform as indicated in FIGS. 11 and 12 of PCT/JP2007/051310.

The cross sectional shape of the recessed portion 41 is not limited to the substantially inverted trapezoidal form, but may be formed as an inverted triangle form obtained by adjusting the focus of the laser beam. The rising angle of the inclined surface of the recessed portion 41 may be steeply set within a range of 50 degrees to 80 degrees. In this case, it is likely that the effect/function of the present invention can be advantageously exhibited. In order to decrease the angle of the recessed portion 41, the diameter of the laser irradiating portion may be decreased.

The recessed portions 41 may be made by mechanical means instead of the laser processing.

Although the present invention was described in detail with reference to the above examples, this invention is not limited to the above disclosure and every kind of variations and modifications may be made without departing from the scope of the present invention.

1. A foil sealed lamp, comprising:
an airtight container having a light emission portion in which a space is formed and a sealing portion provided at least one end of the light emission portion;
a metallic foil with a thickness of T (μm) sealed in the sealing portion;
a conductor of which one end is connected with the metallic foil and of which the other end extends into the space;
wherein a plurality of recessed portions are formed on a main surface of the metallic foil so as not to be overlapped one another under the condition that when a depth of the recessed portion is defined as “D (μm)”, a relation of 1.0 μm≦D<T (μm) is satisfied.

2. The foil sealed lamp as set forth in claim 1,
wherein a relation of 10 μm≦W<100 μm is satisfied wherein a width of the recessed portion is defined as “W (μm)”.

3. The foil sealed lamp as set forth in claim 1,
wherein the recessed portion has a protrusion rising up from a non-processed surface and a depressed portion sinking from the non-processed surface.

4. The foil sealed lamp as set forth in claim 1,
wherein the recessed portions are formed regularly on the main surface of the metallic foil.

5. The foil sealed lamp as set forth in claim 1,
wherein the main surface of the metallic film includes a front surface and a rear surface of the metallic film, and the recessed portions on the front and rear surfaces are shifted one from another.

6. The foil sealed lamp as set forth in claim 1,
wherein the recessed portions are continuously formed on the main surface of the metallic foil so as to be contacted with one another.

7. The foil sealed lamp as set forth in claim 1,
wherein the recessed portions are continuously formed on the main surface of the metallic foil in a manner that the recessed portion is contacted with at least one of other recessed portions in a lateral arrangement direction and vertical arrangement direction of the recessed portions.

8. The foil sealed lamp as set forth in claim 1,
wherein the recessed portions are continuously formed on the main surface of the metallic foil in a manner that each of the recessed portions is contacted with at least two of the recessed portions.

9. The foil sealed lamp as set forth in claim 1,
wherein additional recessed portions are formed at gaps between adjacent ones of the recessed portions in a manner that a width of the additional recessed portion is smaller than a width of the recessed portions.

10. The foil sealed lamp as set forth in claim 1,
wherein the metallic foil includes a knife-edge portion at an end thereof in a short direction thereof and no recessed portion is formed at an area of the knife-edge portion where a thickness is smaller than a depth of the recessed portion.

11. The foil sealed lamp as set forth in claim 1,
wherein the recessed portions are formed by means of laser irradiation.

12. The foil sealed lamp as set forth in claim 1,
wherein a metallic halide is included in the space of the light emission portion.

13. The foil sealed lamp as set forth in claim 1,
wherein mercury is not substantially included in the space of the light emission portion.
